(19) United States
(12) Patent Application Publication
(10) Pub. No.: US 2015/0121376 A1
(43) Pub. Date: Apr. 30, 2015

(54) MANAGING DATA TRANSFER

(71) Applicant: Samsung Electronics Co., Ltd., Gyeonggi-do (KR)

(72) Inventors: Craig Graham, Middlesex (GB); Lovene Bhatia, Middlesex (GB)

(21) Appl. No.: 14/524,952

(22) Filed: Oct. 27, 2014

(30) Foreign Application Priority Data
Oct. 25, 2013 (GB) 1318913.9
Sep. 1, 2014 (KR) 10-2014-0115135

(51) Int. Cl. G06F 9/455; G06F 9/54

(52) U.S. Cl. CPC G06F 9/45533; G06F 9/54
USPC 718/1

(57) ABSTRACT

A method is provided for managing payload data transfer between a first virtual machine and a second virtual machine. The first virtual machine and the second virtual machine are supported by a host environment including a plurality of virtual machines. The method includes determining whether the payload data to be transferred from the first virtual machine to the second virtual machine has a payload data size exceeding a first threshold. The method also includes selecting a transfer medium for the payload data dependent on the determination.

### CROSS-REFERENCE TO RELATED APPLICATION(S) AND CLAIM OF PRIORITY

The present application is related to and claims the benefit under 35 U.S.C. §119(a) of United Kingdom Patent Application No. 1318913.9 filed on Oct. 25, 2013 and Korean Patent Application No. 10-2014-0115135 filed on Sep. 1, 2014, the disclosures of which are hereby incorporated in their entirety by reference.

### TECHNICAL FIELD

This disclosure relates to managing data transfer and, in particular to managing payload data transfer between virtual machines.

### BACKGROUND

Hardware virtualization is a well understood technology; however its application to very complex hardware subsystems (ones requiring a large amount of information to capture/restore their state) is prohibitively labor intensive, with that effort being specific to each subsystem, and may not be reusable as new generations of hardware are developed.

Where several virtual machines (VMs) are located on the same physical device there is often a necessity for these VMs to communicate by sending messages (such as application programming interface (API) requests) between each other.

Several solutions for this currently exist, but their origins in distributed computing (server farms and cloud systems) or in higher resource desktop machines mean that they do not use the most efficient mechanisms for transmitting API requests between VMs.

Transport mechanisms can use either a TCP/IP network link for their transport, or a large first-in-first-out (FIFO) buffer for their communications. Such FIFO buffers are often very large in order to communicate API requests carrying large data payloads.

Using a very large FIFO buffer suffers from resources in terms of FIFO buffer size when used on resource constrained embedded systems, where the buffer consumes a significant amount of the available system resources.

Network based implementations (derived from the server based systems) suffer from well documented performance issues inherent with utilizing the network layer for high bandwidth communication in a virtual machine environment. Such drawbacks include overheads in both the network stack and from the underlying page manipulation used for the virtual network device.

### SUMMARY

To address the above-discussed deficiencies, it is a primary object to provide a method of managing payload data transfer between a first virtual machine and a second virtual machine, wherein the first virtual machine and the second virtual machine are supported by a host environment comprising a plurality of virtual machines. The method includes determining whether the payload data to be transferred from the first virtual machine to the second virtual machine has a payload data size exceeding a first threshold. The method also includes selecting a transfer medium for the payload data dependent on the determination.

The method may also include committing the payload data to a transport packet to be transferred via a ring buffer if the payload data size does not exceed the first threshold.

If the payload data size exceeds the first threshold, the method may also include comparing the payload data size to a second threshold, the second threshold being greater than the first threshold. The method may also include, if the payload data size exceeds the second threshold, allocating at least part of the payload data to a bulk transfer channel, or if the payload data size does not exceed the second threshold, allocating at least part of the payload data to a shared heap.

The method may also include committing metadata and any payload data not allocated to the bulk transfer channel or shared heap to a transport packet to be transferred via a ring buffer.

The metadata may include a shared heap reference tag or a bulk transfer channel reference tag referring to the at least part of the payload data allocated to the shared heap or to the bulk transfer channel respectively.

The method may also include committing the at least part of the payload data allocated to the shared heap to the bulk transfer channel in response to a determination that allocating to a shared heap has been unsuccessful.

Selecting a transfer medium dependent on the determination may include allocating at least part of the payload data to a bulk transfer channel if the payload data size exceeds the first threshold.

The first threshold may correspond to a maximum amount of payload data that is transferable in a transport packet via a ring buffer.

Transfer via the ring buffer may be asynchronous.

Transfer via the shared heap may be asynchronous.

The first virtual machine may include an application and the second virtual machine may comprise an API server.

The payload data may comprise an API request.

The method may also include transferring the payload data using the selected transfer medium.

The host environment may include a physical device having a plurality of virtual machines stored thereon.

According to one embodiment, a non-transitory computer-readable storage medium have instructions stored thereon that, when executed by a processor, perform the method of any preceding method.

A plurality of transport mechanisms may run on the computing device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a schematic of a system according to one embodiment of the disclosure;

FIG. 2 illustrates a schematic of an inter-domain communication channel;

FIG. 3 illustrates a schematic of a packet;

FIG. 4 illustrates a process of an embodiment of the disclosure;

FIG. 5 illustrates a schematic of the shared heap structure; and

FIGS. 6-9 illustrate schematic of embodiments of the disclosure.

### DETAILED DESCRIPTION

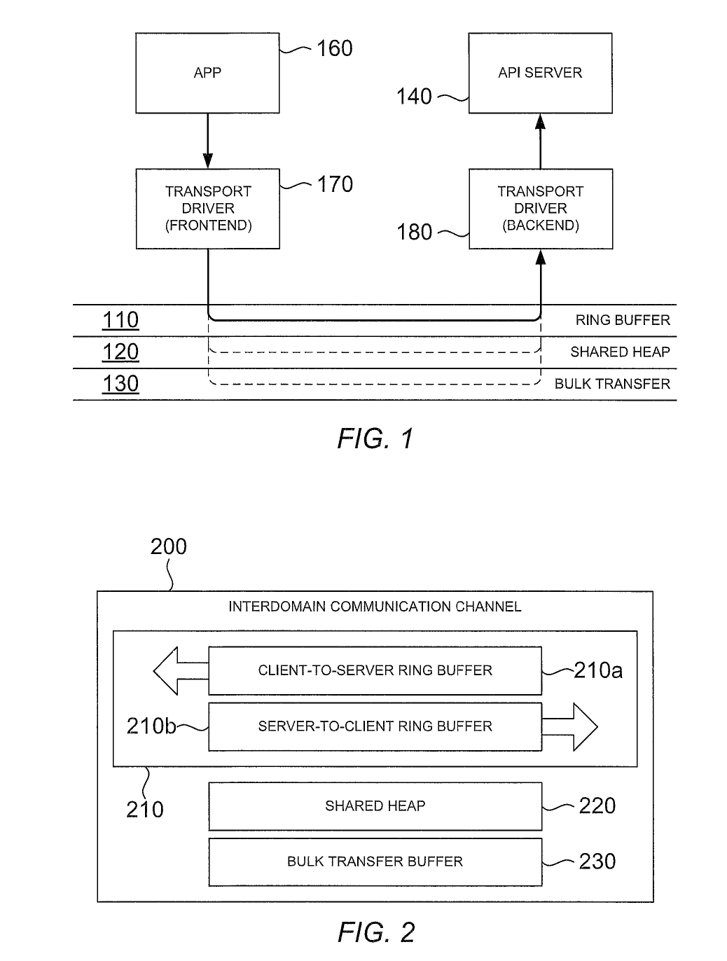

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system and method.

Embodiments of the disclosure are operable on devices, for example mobile devices such as smartphones or tablets. Indeed, the embodiments described below are particularly useful for any device that runs graphically intensive applications in resource constrained environments.

For illustrative purposes, the physical device on which embodiments are carried out may be referred to as a mobile device. It should be understood that the mobile device comprises hardware components conventionally found in mobile devices such as a processor, memory, a display (which may be a touchscreen), audio input/output. Such devices may connect with known telephony networks (e.g. 3G or 4G) and with other networks (such as WiFi) that allow access to the internet using conventional interfaces.

The processor may be any type of processing circuitry. For example, the processing circuitry may be a programmable processor that interprets computer program instructions and processes data. The processing circuitry may include plural programmable processors. Alternatively, the processing circuitry may be, for example, programmable hardware with embedded firmware. The processing circuitry or processor may be termed processing means.

The term ‘memory’ when used in this specification is intended to relate primarily to memory comprising both non-volatile memory and volatile memory unless the context implies otherwise, although the term may also cover one or more volatile memories only, one or more non-volatile memories only, or one or more volatile memories and one or more non-volatile memories. Examples of volatile memory include RAM, DRAM, SDRAM and the like. Examples of non-volatile memory include ROM, PROM, EEPROM, flash memory, optical storage, magnetic storage, and the like.

The physical device can support one or more virtual machines (VM) which can execute operating systems (OS) and software applications that may be stored in the memory of the device. The operation of VMs on a physical device may be controlled by a hypervisor.

FIG. 1 illustrates a schematic representation of a system 100 in which the relationship VMs located at the frontend and backend is shown.

A VM located at the front end (i.e. at the client end) has one or more applications 160 running thereon. The number of applications 160 run on each frontend VM is dependent on the security or isolation requirements of the application being run. Applications that are run on the same VM communicate between themselves using conventional APIs.

A backend VM may have an API server 140 located thereon. The backend VM can host many different virtual backend APIs depending on the applications that are running on one or more front end (or client) VMs.

The frontend application 160 and the API server 140 located at the backend can communicate with each other. Messages such as application programming interface (API) messages may be sent between a frontend transport driver 170 and a backend transport driver 180.

These messages may be sent through a 3-layer transfer mechanism. A packet may be sent through the ring buffer 110. Payload data that cannot be transferred via the ring buffer 110 may be transferred via a shared heap 120 or a bulk transfer 130. The transfer mechanism by which the transfer medium is selected is described hereinafter.

Preferably, these messages are sent asynchronously so that no reply message is needed. Sending messages asynchronously reduces the processing and latency footprint on the system. As the primary overhead when making calls between virtual machines is the number of “domain swaps” (the number of times a physical CPU switches between virtual CPUs), this is a principal requirement for the system. This is particularly important in 3D rendering which is very resource intensive.

However, in certain circumstances API messages may be sent synchronously between virtual machines, i.e. where a reply message is sent.

The vast majority of API calls (or messages) carry relatively small payload data, but occur with high frequency. These small payload data calls occur with high frequency.

However, relatively infrequent API calls may carry very large amounts of data. The ratio of low payload data to high payload data API calls may be in excess of 4000:1 in number.

It would therefore be advantageous to select a transfer medium for the payload data dependent on the size of the payload data to be transferred.

The transport mechanism is based on moving one or more messages (e.g. API messages) from the frontend application 160 located on a VM to the backend API server 140 located on another VM via an inter-domain communication channel 200 shown in FIG. 2.

In an embodiment, the inter-domain communication channel 200 comprises a ring buffer layer 210, a shared heap layer 220 and a bulk transport channel (BTC) layer 230. The transport mechanism is based on a fallback approach.

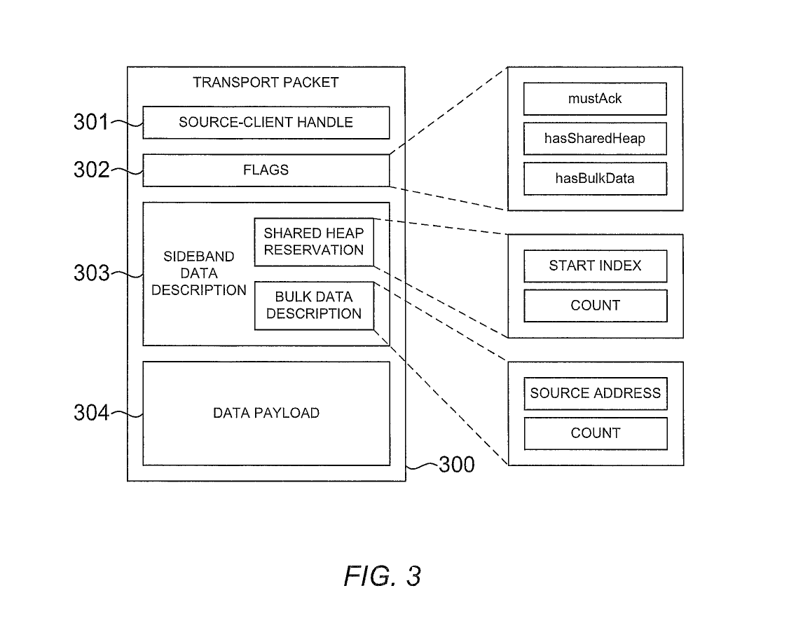

FIG. 3 illustrates a transport packet 300 which can be transferred through the ring buffer 210.

The transport packet 300 comprises a source client handle 301 which is a unique identifier associated with each frontend client which is utilizing the transport mechanism.

The transport packet 300 may also comprise one or more flags 302 which provide control for handling of the packet 300 to the receiving end to utilize the appropriate transport layer(s). Exemplary flags might include a flag telling the receiver to send an acknowledgment (i.e. a synchronous message) or a flag telling the receiver that payload data has been committed to the shared heap or BTC.

The transport packet 300 may also comprise a Sideband Data Description 303 which provides the information used for large data transfers (either via the Shared Heap or the Bulk Transport Channel).

The transport packet 300 also comprises a small Data Payload 304 which provides in-packet transport for small amounts of payload data.

In one or more embodiments, if a message cannot be sent entirely within the ring buffer layer 210, it attempts to use a block in the shared heap 220 to supplement the ring layer packet which is also asynchronous but has limited availability. When a shared heap block of suitable size is not available, the transport mechanism falls back to using the synchronous bulk transport channel 230.

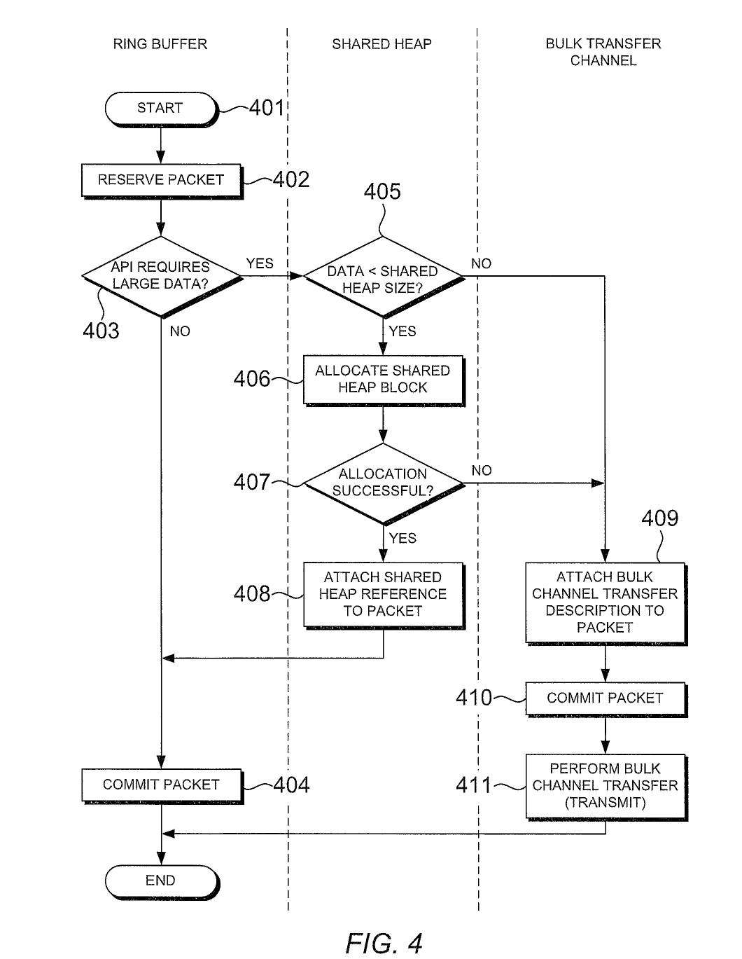

FIG. 4 illustrates a process followed by the transport mechanism to select a transport medium according to an embodiment.

At block 401 the process begins.

At block 402, a transport packet may be reserved for transport via the ring buffer.

At block 403, the sender of the API message determines whether the size of the payload data to be sent from the frontend application 160 to the backend API server 140 exceeds a ring buffer threshold for transport by the ring buffer layer only.

If it is determined that the payload data size does not exceed the threshold for transport by the ring buffer layer only, the transport packet 300, containing the payload data, is committed to the ring buffer at block 404.

If it is determined that the payload data size does exceed the threshold for transport by the ring buffer layer only, the payload data size may be compared to a shared heap threshold at block 405.

The shared heap threshold may be thought of as the data size threshold up to which any payload data that is not transported via the ring buffer can be transported via the shared heap layer. The shared heap threshold will depend on memory availability within the shared heap and may vary if the spare capacity of the shared heap changes.

If the payload data size does not exceed the shared heap threshold, i.e. the shared heap layer may be utilized; a block within the shared heap is allocated (at block 406) for the payload data that cannot be transported through the ring buffer and this payload data is committed to the shared heap.

Block 407 may be an optional block where it is determined whether allocation to the shared heap at block 406 was successful. If the allocation was not successful then the payload data that was intended to be transported via the shared heap is allocated to the BTC instead.

At block 408 a shared heap reference tag is added (for example as a shared heap reservation) to the transport packet 300 so that the shared heap block with the payload data committed thereto may be accessed after the transport packet 300 has been received at the backend. The transport packet 300 is then committed to the ring buffer in a similar manner to the block 404 described above.

If the payload data size does exceed the shared heap threshold the bulk transport channel (BTC) is used instead of the shared heap.

A BTC reference tag may be added (for example as a BTC reservation) to the transport packet 300 so that the BTC block with the payload data committed thereto may be accessed after the transport packet 300 has been received (block 409). The transport packet 300 is then committed to the ring buffer (block 410) in a similar manner to the block 404 described above.

A block within the BTC is allocated for the payload data that cannot be transported through the ring buffer or the shared heap and this payload data is committed to the BTC at block 411.

It will be understood that in situations in which either the shared heap layer or BTC layer is utilized to transport at least part of the payload data, a transport packet 300 is still sent through the ring buffer containing the metadata 301-303 as well as any payload data that is not transported via the shared heap or BTC channels.

For example if a message has a payload comprising both text (having small data size) and an image (having a much larger data size), the payload data size would likely exceed the ring buffer threshold. The image could then be committed to either the shared heap or the bulk channel (depending on the size of the image data according to the process described above). The packet is sent through the ring buffer and contains the text part in the small data payload 304.

In alternative embodiments, the shared heap may be omitted. In other words, a two-layer transport mechanism may be provided. In this embodiment, payload data is sent via the ring buffer and, as a fallback, a bulk transport channel is provided to carry any payload data that cannot be transported via the ring buffer.

### Ring Buffer Layer

The structure of ring buffer layer, the shared heap layer and the bulk transport channel layer will now be described.

Referring again to FIG. 2, the ring buffer layer comprises two unidirectional ring buffers. A client to server ring 210a provides message transport from the client (frontend VM) to the server (backend VM). A server to client ring 210b provides a path from the backend VM to the frontend VM. Each ring buffer may be structured to comprise an index ring and a transport packet array.

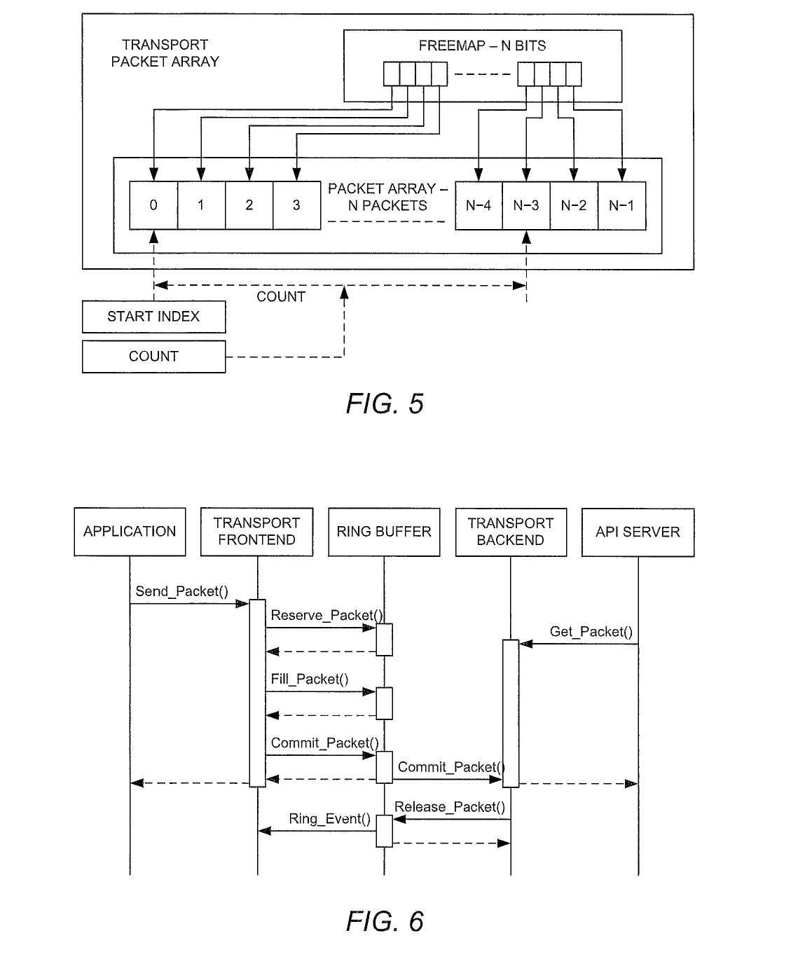

Transport packets are allocated via a free map or allocation map, and the index N of an allocated transport packet is the value written into the index ring as shown in FIG. 5.

The decoupling of the ring buffer and transport packet via the index rings (and their reserve/commit/release protocol) allows for zero-copy processing of message packets. The packets may remain in use at the receiving end and be passed around by reference, only being released once processing is completed.

As previously stated, individual messages in the ring buffers have a relatively small data size. The size of an individual message may be chosen so that the payload of each API message may be fitted into a single message for a majority of API messages. In other words the majority of API messages are sent via the ring buffer layer without using the shared heap or BTC.

An example size of an API message would be 92 bytes. This relatively small size allows for a very large number of messages to be in transit through the message channel (i.e. a very large number of messages can be held in the ring buffer at any one time), without requiring a large amount of memory. This feature helps to meet the API message frequency requirement for the interface.

In one example where Android Jellybean is run in a virtual environment, a packet size of 92 bytes allows 98% of OpenGLES API messages to be sent via the ring buffer without using the shared heap or the BTC.

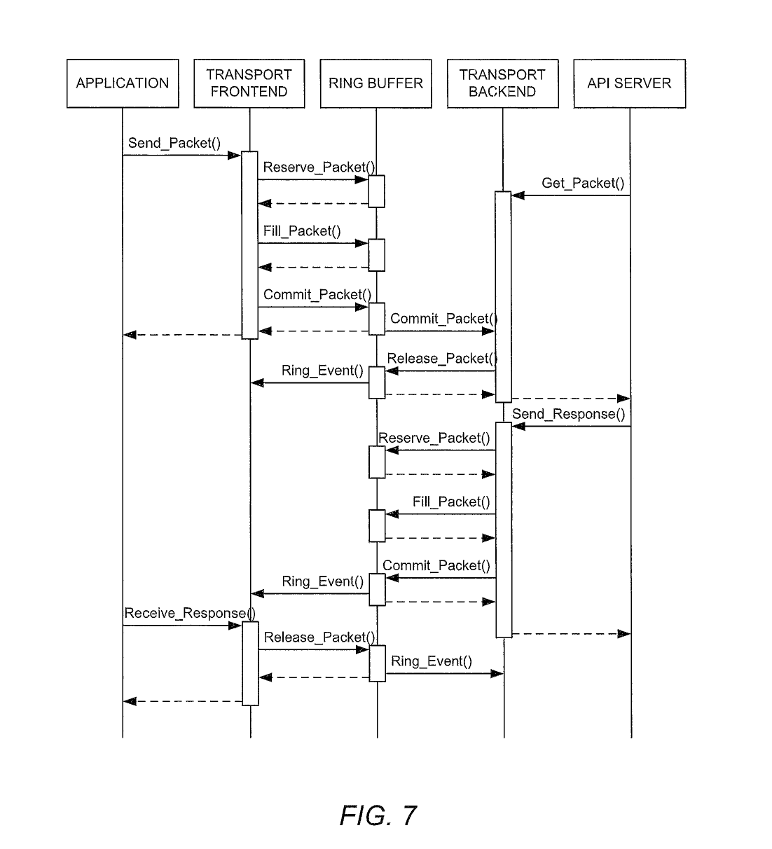

The sequence of operations needed for asynchronous transfer using the ring buffer only is shown in FIG. 6. When an API is to return values to the client (i.e. perform a synchronous call), a sequence of operations used for synchronous transfer using only the ring buffer is performed and is shown in FIG. 7. It is a matter for the individual API implementation making use of the transport mechanism as to when and if to employ the synchronous communication variant.

Shared Heap Layer

The shared heap layer is provided to maintain asynchronous behavior in the situation where the message payload is larger than an individual transport packet can accommodate.

The shared heap is a structure that allows one virtual machine to allocate a block of memory for transmission, and permits another virtual machine to release that memory on reception.

The Shared Heap allows large blocks of data to be allocated by the sending domain and attached to the message packets transmitted via the ring buffers. There is a single shared heap for the communication channel, which is used for both high bandwidth frontend-to-backend communications and low bandwidth backend-to-frontend communication.

FIG. 5 illustrates the structure of the shared heap. The shared heap is a block of contiguous pages of memory (the heap) shared between the frontend domain and the backend domain. The shared heap has an additional management page (or pages) containing an allocation bitmap, where each bit indicates the allocated/free state of a given page within the shared heap. Atomic bit manipulation operations are used to set or clear bits (allocating or releasing pages). Blocks of pages can be allocated by the transmitting VM, and freed by the receiving VM.

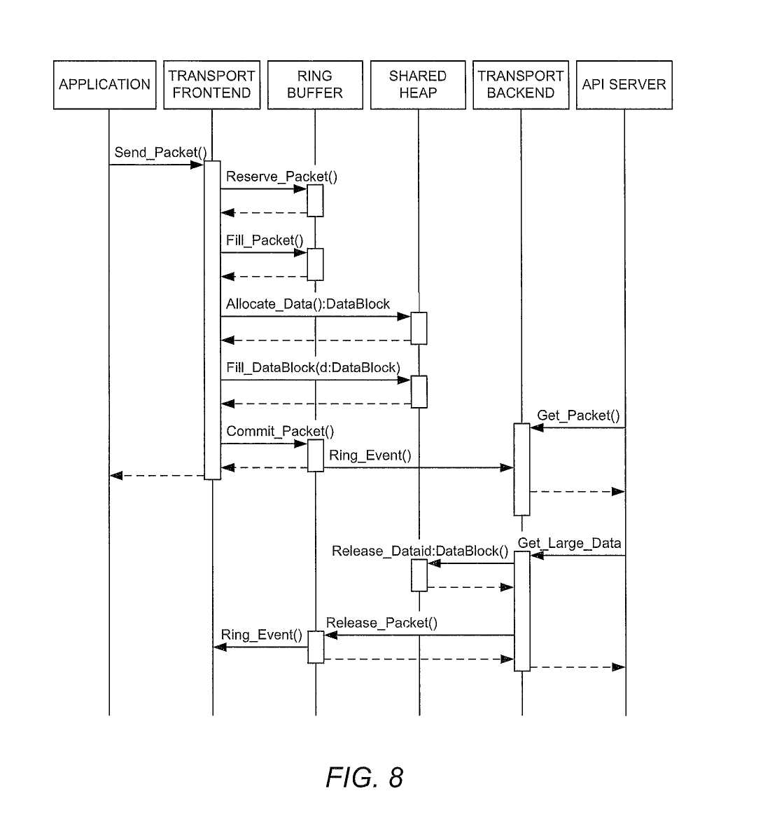

The sequence of operations showing transmission via the Shared Heap layer is shown in FIG. 8.

An advantage of embodiments that use the Shared Heap is to expand the range of payload sizes which may be asynchronously supported, whilst maintaining a relatively low memory footprint.

In the application of GPU virtualization, almost all API messages are sent asynchronously. Maintaining asynchronicity when sending large amounts of data is important since it contributes to a high throughput in a graphics system.

In an alternative embodiment of the disclosure a recirculating ring buffer is provided as a shared heap allocator in place of the allocation map/free map. This allows use of Memory Management Units of the respective devices and virtual CPUs for resolving the non-linearity in data payloads. When the Shared Heap allocation map is not appropriate for a given system, this alternative would allow the three layer architecture to be maintained.

Bulk Transfer Channel

The bulk transfer channel is a further fallback layer of the transport mechanism. The bulk transfer channel provides a single large block of memory shared between domains. Data is moved between virtual machines by a simple repeated fill/drain process.

The bulk transfer channel has the following attributes:

Multiple clients (i.e. frontend VMs) may have Bulk Channel transfers pending. Only one client may actively transfer data via the Bulk Channel at a time. Messages sent through the Bulk Channel can be synchronous.

The backend virtual machine selects which frontend client process it will perform a Bulk Channel transfer with.

The bulk transfer channel is another block of contiguous pages similar to the shared heap. It has a different control structure though, whereby a single transfer is given total ownership of the entire block of pages (the whole bulk channel), and the entire transfer is performed until completion by repeatedly copying data into the bulk channel pages in the source VM and out of the shared pages into the used target memory in the receiving VM.

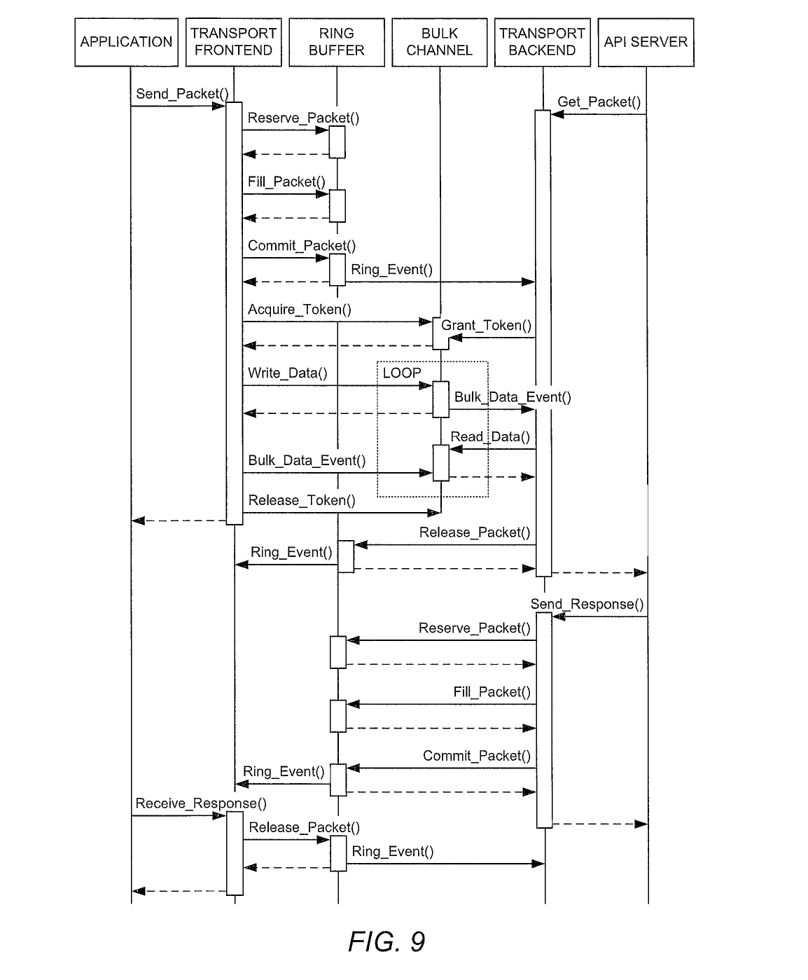

The sequence of operations showing transmission via the bulk channel is shown in FIG. 9.

As discussed above, embodiments of the disclosure described herein are applicable to the area of Application Programming Interface (API) virtualization when running multiple virtual machines on the same physical device.

Embodiments of the disclosure provide high performance transport with a comparatively low footprint.

One specific application of this technology is for Graphics Processing Unit (GPU) virtualization. Each packet sent via transport mechanism from the frontend to the backend contains the details of a single call to the GPU vendors' native API. The backend API server makes the call to the GPU via the GPU interface libraries provided by its manufacturer (for example, Nvidia, ARM, Imagination, and the like). The GPU does not communicate with the applications directly; instead the GPU communicates with the backend API server. It will be appreciated that application programs drive the GPU and send requests. The GPU does not need to request items from an application.

Embodiments that use the 3 layer fallback method provide for lower memory overheads than using a basic cross domain large, shared FIFO buffer, whilst maintaining the flexibility of asynchronously supporting high frequency, low payload size messages at the same time as supporting lower frequency high payload messages.

Multiple instances of the transport mechanism can exist in parallel at the backend in order to support communication between multiple frontend virtual machines and the backend.

It will be appreciated that the above described embodiments are purely illustrative and are not limiting on the scope of the disclosure. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of managing a transfer of payload data between a first virtual machine and a second virtual machine, wherein the first virtual machine and the second virtual machine are supported by a host environment comprising a plurality of virtual machines, the method comprising:
determining whether the payload data to be transferred from the first virtual machine to the second virtual machine comprises a payload data size exceeding a first threshold; and
selecting a transfer medium for the payload data dependent on the determination.

2. The method of claim 1, further comprising committing the payload data to a transport packet to be transferred via a ring buffer if the payload data size does not exceed the first threshold.

3. The method of claim 1, wherein, if the payload data size exceeds the first threshold, the method further comprises:
comparing the payload data size to a second threshold, the second threshold being greater than the first threshold, and
if the payload data size exceeds the second threshold, allocating at least part of the payload data to a bulk transfer channel, or
if the payload data size does not exceed the second threshold, allocating at least part of the payload data to a shared heap.

4. The method of claim 3, further comprising committing metadata and any payload data not allocated to the bulk transfer channel or shared heap to a transport packet to be transferred via a ring buffer.

5. The method of claim 4, wherein the metadata comprises a shared heap reference tag referring to the at least part of the payload data allocated to the shared heap or a bulk transfer channel reference tag referring to the at least part of the payload data allocated to the bulk transfer channel.

6. The method of claim 3, further comprising committing the at least part of the payload data allocated to the shared heap to the bulk transfer channel in response to a determination that allocating to a shared heap has been unsuccessful.

7. The method of claim 1, wherein selecting the transfer medium dependent on the determination comprises allocating at least part of the payload data to a bulk transfer channel if the payload data size exceeds the first threshold.

8. The method of claim 1, wherein the first threshold corresponds to a maximum amount of the payload data that is transferable in a transport packet via a ring buffer.

9. The method of claim 8, wherein transfer via the ring buffer is asynchronous.

10. The method of claim 3, wherein transfer via the shared heap is asynchronous.

11. The method of claim 1, wherein the first virtual machine comprises an application and the second virtual machine comprises an API server.

12. The method of claim 1, wherein the payload data comprises an API request.

13. The method of claim 1, further comprising transferring the payload data using the selected transfer medium.

14. The method of claim 1, wherein the host environment comprises a physical device having the plurality of virtual machines stored thereon.

15. An apparatus, comprising:
at least one memory configured to store a first virtual machine and a second virtual machine supported by a host environment comprising a plurality of virtual machines;
at least one processor configured to determine whether payload data to be transferred from the first virtual machine to the second virtual machine comprises a payload data size exceeds a first threshold and select a transfer medium for the payload data dependent on the determination.

16. The apparatus of claim 15, further comprising the at least one processor configured to commit the payload data to a transport packet to be transferred via a ring buffer if the payload data size does not exceed the first threshold.

17. The apparatus of claim 15, wherein, if the payload data size exceeds the first threshold, the at least one processor is further configured to:
compare the payload data size to a second threshold, the second threshold being greater than the first threshold, and
if the payload data size exceeds the second threshold, allocate at least part of the payload data to a bulk transfer channel, or
if the payload data size does not exceed the second threshold, allocate at least part of the payload data to a shared heap.

18. The apparatus of claim 17, further comprising the at least one processor configured to commit metadata and any payload data not allocated to the bulk transfer channel or shared heap to a transport packet to be transferred via a ring buffer.

19. The apparatus of claim 18, wherein the metadata comprises a shared heap reference tag referring to the at least part of the payload data allocated to the shared heap or a bulk transfer channel reference tag referring to the at least part of the payload data allocated to the bulk transfer channel.

20. A non-transitory computer-readable storage medium having stored thereon computer-readable code, which, when executed by a processor, causes the processor to:
determine whether payload data to be transferred from the first virtual machine to the second virtual machine comprises a payload data size exceeds a first threshold, the first virtual machine and the second virtual machine are supported by a host environment comprising a plurality of virtual machines; and
select a transfer medium for the payload data dependent on the determination.

21. The storage medium of claim 20 wherein a plurality of data transport mechanisms are operable on the processor.
